(19) United States
(12) Patent Application Publication
(10) Pub. No.: US 2007/0183968 A1
(43) Pub. Date: Aug. 9, 2007

(54) Water-gas shift and reforming catalyst and method of reforming alcohol

(76) Inventors: Todd Healey, Spokane, WA (US); Peter David DeVries, Spokane, WA (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/498,844

(22) Filed: Aug. 3, 2006

Related U.S. Application Data
(60) Provisional application No. 60/705,233, filed on Aug. 3, 2005.

(51) Int. Cl. B01J 23/00

(52) U.S. Cl. 423/656; 502/325; 502/304; 502/303; 502/343

(57) ABSTRACT

A supported catalyst for reforming alcohol, particularly for steam reforming methanol, to produce hydrogen for use in fuel cells includes a ceramic support and a catalyst coated thereon. The catalyst contains at least one platinum group metal such as platinum, iridium, rhenium, palladium, or osmium, and where the at least one platinum group metal is reduced, and is also coated with a lanthanide group metal or metal oxide. Preferably, the catalyst contains at least 0.05% by weight of at least one platinum group metal, at least 0.05% by weight of an at least one metal or metal oxide of cerium or lanthanum, and at least 0.05% by weight of an at least one metal or metal oxide of chromium, manganese, or iron.

### CROSS REFERENCE TO RELATED APPLICATION

This application claims priority to U.S. Provisional Patent Application No. 60/705,233, filed Aug. 3, 2005.

### FIELD OF THE INVENTION

This invention relates to a catalyst for reforming alcohol-water mixes into hydrogen. Various catalyst combinations are disclosed which facilitate the release of hydrogen from the reforming reaction, while converting the carbon in the alcohol into gaseous oxides of carbon, preferably carbon dioxide. A method for utilizing this catalyst in reforming reactions is also described. The catalyst is particularly suited for the reformation of methanol at temperatures between 325-450° C.

### BACKGROUND OF THE INVENTION

Hydrogen-powered fuel cells have been developed to the point where they are nearly ready for full-scale commercial introduction. Unfortunately, the source of hydrogen has continued to be a problem, and this has limited many demonstration projects to bottled hydrogen as a fuel source. Reformers for converting alcohols and petroleum compounds into hydrogen are being actively pursued by a wide variety of companies. The easiest fuels for reforming are arguably alcohols, since they may be mixed with water.

The membrane-purification method of reforming is one of the simplest and most efficient methods of converting liquid fuels into pure hydrogen for fuel cell use. With this method, alcohol and water are pressurized, heated and sent to a catalyst bed. The catalyst ideally converts the carbon in the alcohol to carbon dioxide using the oxygen from the water. The hydrogen in the water and alcohol is separated from the parent molecules, forming gaseous hydrogen which mixes with the carbon dioxide. The hydrogen can then be selectively passed through a palladium-based membrane, yielding purified hydrogen that can be sent to a fuel cell.

In order for a reformer of this type to perform well, the catalyst must:

Possess high activity for the decomposition of methanol and the oxidation of CO to CO₂

Be highly selective towards the production of hydrogen

Exhibit durability over a wide temperature range (300-450° C.)

Minimize carbon formation in the catalyst (“coking”)

Exhibit high catalyst lifetime and activity

At present a catalyst with these properties has not been identified in the art. The traditional methanol reforming catalyst, copper-zinc-oxide, must be kept between 250-280° C., and has poor long-term stability at higher temperatures due to sintering of the small catalyst particles into larger particles. To date, nearly all the methanol reformers reported in the literature have utilized the copper-zinc-oxide catalyst. However, since Pd-based membranes must be kept at a temperature above the hydrogen-embrittlement point of the metal (>280° C. for PdAg), the temperatures of the reformed gases exiting a CuZnO catalyst bed are too low for introduction to a PdAg purifier membrane.

In U.S. Pat. No. 5,336,440 Kiyoura et. al (Mitsui Toatsu Chemicals, Inc.) disclose a method for modifying chromium-zinc catalyst for methanol decomposition. Their method enabled the reaction to proceed with 6.5% (volume) water, with the resulting formation of CO, C0₂, and H₂. Other side reaction products are nearly non-existent, and they note that the amount of CO can be reduced if desired by adding more water. Some samples were tested up to 265 days, and significant coking did not occur. Furthermore, the activity of the catalyst did not significantly degrade as tested by Kiroura et. al at the tested temperatures between 300-400° C. However, because this catalyst as reported by Kiyoura et. al is an unsupported catalyst, it tends to form a loose powder upon fabrication, making it unsuitable for use in reformers unless it was somehow post-processed or form pressed. Further, the catalyst does not exhibit sufficiently high activity for the formation of C0₂, which is also needed for effective reforming.

Some additional reports detail the reforming of ethanol using a Cu—Ni catalyst. (“Steam reforming of ethanol using Cu—Ni supported catalysts”, Studies in Surface Science and Catalysis (2000), 130C (International Congress on Catalysis, 2000 pt. C), pg. 2147-2152.) However, it has been discovered that the copper utilized in Cu—Ni formulations for methanol and ethanol reforming eventually sinters during operation, limiting the life of the Cu—Ni catalyst (other formulations with copper, which did not contain nickel, also sinter over time, reducing their activity). Further, the presence of nickel invariably causes the formation of some methane, rather than the desired formation of CO₂ or hydrogen. This limits the suitability of the Cu—Ni combination for alcohol reforming in general.

Precious metals may also be used as catalysts to reform alcohols. Platinum (Pt) and palladium (Pd) were tested and found to perform the decomposition reaction:

CH₃OH+H₂O→CO+2H₂+H₂O (endothermic)

where the carbon monoxide is generally not converted into carbon dioxide.

In order to convert carbon monoxide into carbon dioxide, a further water-gas shift reaction is needed:

CO+2H₂+H₂O→CO₂+3H₂O (exothermic)

Thus, for Pt or Pd to work effectively as a catalyst for methanol reforming, the decomposition reaction must be followed with a downstream water-gas shift reaction. While there are commercial iron-chrome shift catalysts that work in the temperature range of 300-400° C., heat must be removed during the shift reaction to prevent the catalyst and gases from exceeding the effective temperature of the iron-based shift catalyst. A solution would therefore require a heat exchanger catalyst bed for the endothermic decomposition reaction using Pt or Pd, and a second heat exchanger catalyst bed for the exothermic water-gas shift reaction. As the activity of commercially available iron-based shift catalyst is low, a fairly large water-gas shift catalyst bed would be necessary with this solution. The resulting reformer using this method would be large and complex.

It is far more effective to add the water-gas shift functionality to the decomposition catalyst than to perform the reactions separately. Since the decomposition reaction requires heat, and the water-gas shift reaction gives off heat, performing the reactions on the same catalyst material reduces the heat transfer requirements greatly; a much smaller net amount of heat can be applied to the catalyst to perform the combined reaction. This is what occurs with the CuZnO catalyst previously mentioned; both conversion and shift activity are very high with this catalyst, until sintering occurs.

Some attempts have been made to utilize platinum as a shift catalyst by adding cerium. Zalc et. al deposited Pt on a Ce/Zr support, and tested the water-gas shift activity at 250° C. over a period of time. They found that due to reduction of the cerium support, the catalyst deactivated with a half-life of only 100 hours (J. M. Zalc, V. Sokolovskii, and D. G. Loffler, J. of Catalysis 206, 169-171 (2002)). This short water-gas shift lifetime for Pt on cerium support was also observed at Argonne National Laboratory, where half-lives of 40 to 217 hours were observed for platinum and platinum-metal mixtures over cerium (S. Choung, J. Krebs, M. Ferrandon, R. Souleimanova, D. Myers, and T. Krause, “Water-Gas Shift Catalysis”, FY 2003 Progress Report, Argonne National Laboratory).

A need remains therefore for a durable decomposition and water-gas shift catalyst which can operate in the 300-450° C. range, is suitable for alcohol reforming, and has high decomposition and shift activity.

### SUMMARY OF THE INVENTION

A broad range of catalysts were tested for methanol reforming activity, both in terms of the decomposition and the water-gas shift reactions. Methanol and water were mixed in a 1:1.2 molar ratio, respectively, and preheated to about 350° C. The mix was then introduced to a metal tube containing a catalyst, with external heat to maintain the exit temperature at a set point, which was varied between 300-450° C., depending on the test. Fuel mix flow was measured over time, and the resulting gas composition was analyzed to determine the amount of hydrogen, water, methanol, CO, and CO₂ in the reformed gases. Tube diameters, catalyst support size and type, pressure, and temperatures were varied over the many tests, as well as the catalyst formulations.

Platinum and palladium were tested and found to have good decomposition activity, but little shift activity. The addition of cerium or lanthanum improved the shift activity of both the platinum and the palladium catalyst in a methanol reforming environment.

It was discovered that the platinum-cerium combination could be made highly stable if the cerium is coated on top of reduced platinum, which in turn resides upon an alumina support. Longevity on the order of thousands of hours, with minimal degradation in shift and decomposition activity for methanol reforming, has been recorded for this combination. The stability of this catalyst is attributed to the use of the lanthanide-group metals as a coating rather than a support for the precious metal.

Ce—La coating combinations on Pt/alumina (reduced) samples exhibited shift selectivity of approximately 50% of the possible 100% complete conversion of CO to CO₂. Conversion (decomposition) of the methanol was typically between 95-99%.

To increase shift activity, a variety of promoters were added to examine their effectiveness. It was found that chromium, manganese, and iron were all effective at improving the shift activity at higher temperatures (400-450° C.), with iron markedly improving the shift selectivity at all temperatures. The addition of iron also improved the decomposition activity of the platinum, increasing the methanol conversion to 98-99%.

The ratio of iron to cerium did not appear to have a major impact on the effectiveness of the iron-cerium-platinum combination. A 10:1 Fe:Ce ratio had nearly the same performance as 1:10.

An Fe—Ce/PtIAlumina catalyst has now been tested in a Genesis Fueltech GT-8 methanol reformer (with Pd—Ag purification membrane) for over 8,700 hours with no apparent degradation in catalytic activity, where the catalyst bed outlet temperature is averaging about 360° C. The new catalyst has therefore been shown to be highly active and durable, and well-suited for use in alcohol reforming.

### BRIEF DESCRIPTION OF THE DRAWINGS

In the drawings:

FIG. 1 is a schematic illustration of an apparatus used to test the activity of various catalysts for use in alcohol reforming.

FIG. 2 is a graph showing an average of test results for the shift selectivity of different catalyst groups.

FIG. 3 is a graph of the water-gas shift selectivity of several catalyst combinations over a temperature range.

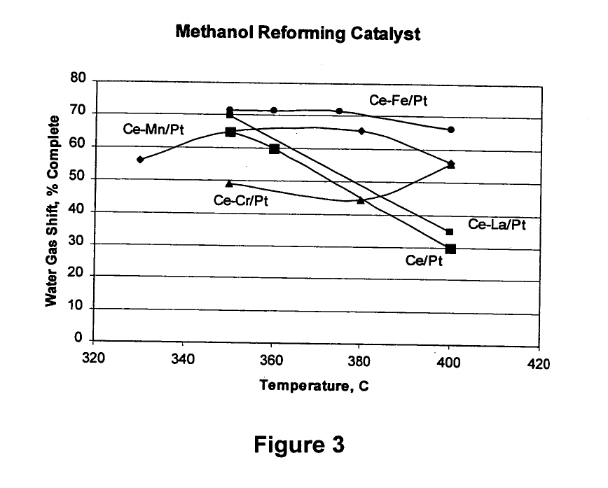

### DETAILED DESCRIPTION OF THE INVENTION

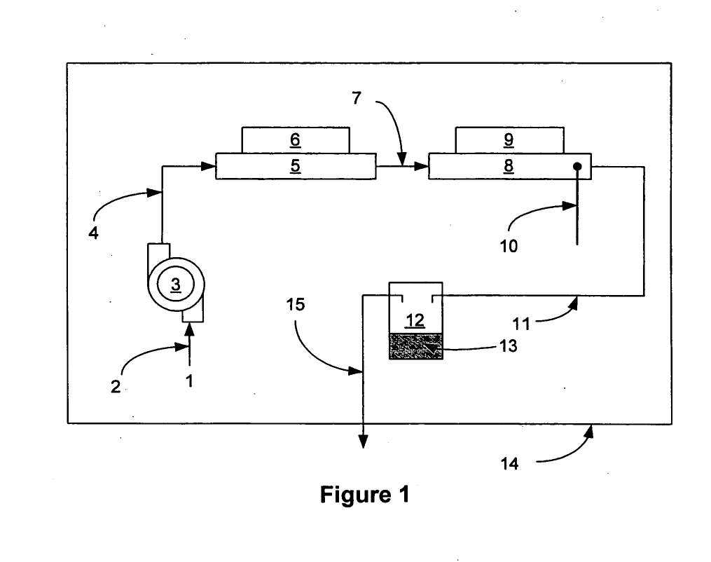

As shown in FIG. 1, methanol-water mix 1 is drawn through supply tube 2 into pump 3 and injected into preheater tube 5 through tube 4. Preheater tube 5 contains a heat source 6 for boiling the fluids and preheating them. Afterwards the mixed vapor 7 is transported to catalyst tube 8 which also has an external heat source 9. Thermocouple 10 is used to control the amount of heat added through heat source 9. Upon exiting the catalyst bed, mixed gases 11 travel through a condenser 12 to collect the liquid constituents 13 for analysis. Remaining gas exits the test fixture apparatus 14 through tube 15, where the gas composition and flow can be measured. As long as the feed rate is carefully measured, the amount of water collected at condenser 12 will be proportional to the amount of the water-gas shift reaction, and the amount of methanol in the liquid will indicate the percentage of completion for the decomposition reaction. The volume and composition of the gas flow out of tube 15 provides independent verification of the shift and decomposition calculations from the condensate.

Below are representative experiments and the results for the various tests. The methanol:water molar feed ratio was 1:1.2 for all experiments. Catalysts are activated in-situ during the reforming process (typically within the first few minutes), without any other preconditioning.

### EXAMPLE 1

Pt/Alumina

⅛″ diameter alpha-Alumina spheres coated with a platinum loading of 1% were purchased from UEC (United Emission Catalyst, Atlanta, Ga.). The samples were not reduced prior to shipment. 50 cc of spheres were loaded into a ½″ diameter stainless steel tube. The feed gas hourly space velocity of methanol and water (25° C., 1 atmosphere pressure basis) was 2,827 h⁻¹, with a pressure of 50 psig, and a catalyst exit temperature of 360° C. The decomposition and shift reactions ran to 96.8% and 3.6%, respectively.

### EXAMPLE 2

Pd/Alumina

SAS 250 (Alcoa Vidalia Works, Vidalia LA) catalyst support, in the form of 1/16″ diameter alpha alumina spheres, were wash coated with a Pd-containing solution (Paladin RDX-1200, RD Chemical Company, Mountain View, Calif.), dried, and subsequently calcined at 750° C. 50 cc of catalyst were loaded into a ½″ diameter stainless steel tube. The feed gas hourly space velocity was 2,973 h⁻¹ at 50 psig, and the catalyst exit temperature was set at 400° C. The decomposition and shift reactions were 90.3% and 4.0%, respectively.

Experiments 1 and 2 both confirm high activity of the Pd and Pt for the decomposition reaction, but poor activity for the water-gas shift reaction.

### EXAMPLE 3a, 3b

Ce—La/Pt/Alumina

1% Pt/alumina UEC catalyst (as Experiment 1) was wash coated with a solution containing cerium and lanthanum nitrate salts in a 9:1 ratio, respectively.

In sample “A”, prior to coating with the nitrate solution, the UEC catalyst was reduced at 400° C. in pure hydrogen for four hours, and cooled in hydrogen. The wash-coated sample was then dried and calcined at approximately 600° C. for over three hours in air. Weight percentage of the metals were Ce_{5.1}La_{0.6}/Pt_{0.9}/Alumina (Weight percentage in all examples is the percentage of the metal as a fraction of the metals plus the support. Metals, such as cerium, lanthanum, and so forth, exist in the oxidized state after calcination, and may or may not reduce during active testing. Since the exact oxidation or reduction of the catalyst elements may not be known, catalyst formulations are listed in all the examples as a listing of the metallic elements and their weight percentages). 50 cc of the calcined catalyst were placed in a ½″ stainless steel tube test fixture, and run with catalyst gas exit temperature of 370° C., a gas hourly space velocity of 2,764 h⁻¹, and a pressure of 60 psig. The methanol conversion (decomposition) was 99.6%, and the shift reaction ran to 62.1%.

Sample “B” was processed and tested identically to sample “A”, excect that the UEC catalyst was not reduced prior to coating the sample with the nitrates. The methanol conversion was 92.4%, and the shift was 36.8%. The performance was stable over 10 hours of testing.

This test therefore definitively concludes that both the conversion and shift activity of the coated Pt catalyst are highly enhanced by first reducing the Pt prior to coating it with lanthanides.

### EXAMPLE 4

Ce/Pt/Alumina

0.5% Pt/alumina catalyst was obtained from Alfa Aesar (stock #89106). The catalyst arrived in the reduced condition. Cerium nitrate was dissolved in water. The platinum catalyst was wash-coated and then dried. The sample was then calcined at approximately 600° C. for three hours in air. The final weight percentage of the deposited metals was Ce_{6.3}/Pt_{0.5}/Alumina. 50 cc of catalyst pellets were placed in the a ½″ stainless steel tube test fixture. The catalyst bed exit temperature was set to 350° C., with a gas hourly space velocity of 3,755 h⁻¹, and a pressure of 50 psig. The conversion was calculated at 99.1%, and the shift was estimated at 63%.

### EXAMPLE 5

Ce—La/Pt/Alumina

0.5% Pt/alumina catalyst was obtained from Alfa Aesar (stock #89106). The catalyst arrived in the reduced condition. 32.5 grams of cerium nitrate and 5.0 gram of lanthanum nitrate were dissolved in 25 ml of water. The platinum catalyst was wash-coated and then dried. The sample was then calcined at approximately 600° C. for three hours in air. The final weight percentage of the deposited metals was Ce_{10.6}La_{1.6}/Pt_{0.4}/Alumina. 50 cc of catalyst pellets were placed in a ½″ stainless steel tube test fixture. The catalyst bed exit temperature was varied, with a gas hourly space velocity of 2,806 h⁻¹, and a pressure of 50 psig. The performance was as follows:

| Temperature | Decomposition % | Shift |
|---|---|---|
| 350° C. | 98.7 | 69.7 |
| 400° C. | 97.6 | 35.0 |

Like example 4 (Ce/Pt/Alumina), the CeLa/Pt/Alumina shows a strong activity dependence upon temperature for the shift reaction, with the selectivity cut in half when the temperature is raised from 350° C. to 400° C.

### EXAMPLE 6

Ce—Cr/Pt/Alumina

1% Pt/alumina UEC catalyst (as Experiment 1) was reduced as in Example 3A, and wash coated with a solution containing cerium and chromium nitrate salts in a 10:1 ratio, respectively. The wash-coated sample was then dried and calcined at approximately 650° C. for three hours in air. The final weight percentages of the metals were Ce_{9.7}Cr6.4P_{0.8}Alumina. 25 cc of the calcined catalyst were diluted with 20 cc of inert alumina-silica catalyst support spheres, and the mixed 45 cc of pellets were placed in the ½″ stainless steel tube test fixture. The catalyst bed exit temperature was varied, with a gas hourly space velocity of 8,647 h⁻¹, and a pressure of 60 psig. The performance was as follows:

| Temperature | Decomposition % | Shift |
|---|---|---|
| 350° C. | 96.5 | 49 |
| 380° C. | 97.8 | 44 |
| 400° C. | 97.9 | 55.6 |

The higher temperature (400° C.) shift activity of this chrome-containing catalyst is much better than the samples with only cerium and lanthanum.

### EXAMPLE 7

Ce—Mn/Pt/Alumina

A catalyst sample was prepared and tested similar to Example 6, but with manganese rather than chromium. The results are shown below:

| Temperature | Decomposition % | Shift |
|---|---|---|
| 330° C. | 95.9 | 56.0 |
| 350° C. | 98.2 | 65.0 |
| 380° C. | 98.0 | 65.4 |
| 400° C. | 97.9 | 55.9 |

The results show improved water-gas shift activity at higher temperatures compared to samples with only cerium and lanthanum.

### EXAMPLE 8

Ce—Fe/Pt/Alumina

0.5% Pt/alumina catalyst (Alfa Aesar) was used. The catalyst arrived in the reduced condition. 20 grams of cerium nitrate and 2.0 gram of iron nitrate were dissolved in water. The platinum catalyst was wash-coated and then dried. The sample was then calcined at approximately 600° C. for three hours in air. The final weight percentage of the deposited metals was Ce_{9.3}Fe_{0.6}/Pt_{0.5}/Alumina. 25 cc of the calcined catalyst were diluted with 20 cc of inert alumina-silica catalyst support spheres, and the mixed 45 cc of pellets were placed in the ½″ stainless steel tube test fixture. The catalyst bed exit temperature was varied, with a gas hourly space velocity of 8,652 h⁻¹, and a pressure of 50 psig. The performance was as follows:

| Temperature | Decomposition % | Shift |
|---|---|---|
| 350° C. | 98.1 | 71.6 |
| 360° C. | 97.9 | 71.3 |
| 375° C. | 98.4 | 71.6 |
| 400° C. | 99.1 | 66.1 |

The results show improved water-gas shift activity at all temperatures compared to samples with only cerium and lanthanum.

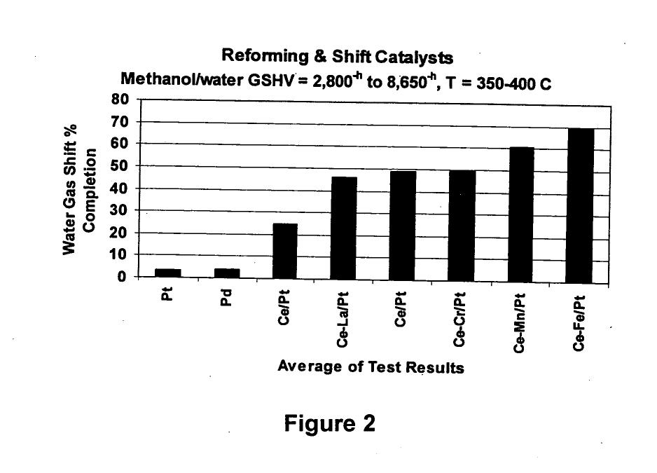

The improvement of the water-gas shift selectivity for Examples 1-8 is shown in FIG. 1 and FIG. 2.

### EXAMPLE 9

Fe—Ce/Pt/Alumina

0.5% Pt/alumina catalyst (Alfa Aesar, ⅛″ diameter spheres) was used. The catalyst arrived in the reduced condition. 15 grams of iron nitrate and 15.0 grams of cerium nitrate were dissolved in 25 ml of water. The platinum catalyst was wash-coated and then dried. The sample was then calcined at approximately 700° C. for three hours in air. The final weight percentage of the deposited metals was Fe_{3.2}Ce_{4.6}/Pt_{0.5}/Alumina. 50 cc of the calcined catalyst was placed in a ½″ Inconel® tube for the catalyst bed. The catalyst was run at a catalyst bed exit temperature set to 350° C. for approximately 95 hours, with a catalyst feed gas hourly space velocity of 2,902 h⁻¹, and a pressure of 130 psig. At the end of the test, the catalyst was still performing at 99.2% methanol conversion, and with the shift reaction running at 82.4% of completion. Performance at the end of the test was slightly better than at the beginning (98.4% conversion, 73.6% shift).

This test results from examples 9 and 10 indicate that the Fe-lanthanide ratio need not be precise in order to attain satisfactory results.

In summary, it has been shown that the platinum-cerium and platinum-lanthanum combination can be made highly stable as a decomposition and shift catalyst if the cerium is deposited upon a reduced platinum surface. Further additives such as manganese, iron, and chrome have been shown to improve the catalytic activity, while additional combinations with other platinum group metals, such as palladium, are possible. The catalyst combinations have been shown to perform at higher temperatures, and possess higher durability than other catalyst systems, particularly in the steam reforming of methanol above 300° C.

I claim:

1. A supported catalyst, comprising a support and a catalyst residing on said support, the catalyst comprising at least one platinum group metal selected from the group consisting of platinum, iridium, rhenium, palladium, ruthenium and osmium, and where the at least one platinum group metal is reduced, and coated with a second metal or metal oxide.

2. A catalyst as claimed in claim 1 where the second metal or metal oxide comprises at least one of cerium, cerium oxide, lanthanum, lanthanum oxide, or zinc oxide.

3. A catalyst as claimed in claim 2 which further comprises at least one of chromium, manganese, or iron in the coating over said reduced platinum group metal.

4. A catalyst as claimed in claim 3, where the platinum group metal comprises either platinum or palladium at a weight percentage less than 5%, and the catalyst weight percentage of the cerium, lanthanum, iron, chromium, or manganese is between 0.05% and 60%.

5. A catalyst as claimed in claim 1 where the support is at least one of a ceramic, cement or a sol-gel.

6. A catalyst as claimed in claim 5 where the support also contains at least one of alumina, zirconia, titania, calcium, zinc oxide or magnesium.

7. A supported catalyst for methanol steam reforming or for water-gas shift reactions, comprising a catalyst residing on a support, and the catalyst comprises at least one platinum group metal selected from the group consisting of platinum, iridium, rhenium, palladium, ruthenium, and osmium, and at least one metal or metal oxide of cerium or lanthanum, and at least one metal or metal oxide of chromium, manganese, or iron.

8. A supported catalyst as claimed in claim 7 where the support is at least one of a ceramic, cement or a sol-gel.

9. A supported catalyst as claimed in claim 8 where the support also contains at least one of alumina, zirconia, titania, calcium, zinc oxide or magnesium.

10. A method for reforming alcohol, comprising the steps of providing a supported catalyst, said catalyst residing on said support and the catalyst comprising at least one platinum group metal selected from the group consisting of platinum, iridium, rhenium, palladium, ruthenium, and osmium, and where the at least one platinum group metal is reduced, and coated with a lanthanide metal or metal oxide, which further contains at least one of chromium, manganese, or iron, or oxides thereof, in the coating over said reduced platinum group metals; heating the catalyst to a temperature between 200° C. and 900° C.; and feeding a heated alcohol and water mixture to the catalyst such that products of at least hydrogen and carbon dioxide are formed.

11. A method for steam reforming methanol, comprising the steps of providing a supported catalyst, said catalyst residing on said support and the catalyst comprising at least one platinum group metal selected from the group consisting of platinum, iridium, rhenium, palladium, ruthenium, and osmium, and where the at least one platinum group metal is reduced, and coated with a metal or metal oxide of at least one of cerium, lanthanum, or zinc which further contains at least one of chromium, manganese, or iron, or oxides thereof, in the coating over said reduced platinum group metal; heating the catalyst to a temperature between 150° C. and 700° C.; and feeding a heated methanol and steam mixture to the catalyst such that products of at least hydrogen and carbon dioxide are formed.

12. A method for performing a water-gas shift reaction with a catalyst, comprising the steps of providing a supported catalyst, said catalyst residing on said support and the catalyst comprising at least one platinum group metal selected from the group consisting of platinum, iridium, rhenium, palladium, ruthenium, and osmium, and where the at least one platinum group metal is reduced, and coated with a metal or metal oxide of at least one of cerium, lanthanum, chromium, manganese, zinc or iron; heating the catalyst to a temperature between 150° C. and 700° C.; and feeding a gas containing carbon monoxide and steam to the catalyst such that products of at least hydrogen and carbon dioxide are formed.

13. A method of making a supported catalyst comprising the steps of depositing platinum onto a support by contacting said support with a liquid solution containing platinum; drying the support; reducing the platinum residing on said support; depositing cerium, lanthanum or zinc onto the reduced supported platinum by contacting the reduced supported platinum with a solution containing cerium, lanthanum, or zinc; and drying the support with the reduced platinum and cerium, lanthanum or zinc thereon.

14. A method for making a supported catalyst as claimed in claim 13, where the liquid solution which contains at least one of cerium, lanthanum, or zinc further contains at least one of iron, manganese, or chromium.

15. A catalyst for methanol steam reforming, comprising at least 0.05% by weight of a platinum group metal selected from the group consisting of platinum, iridium, rhenium, palladium, ruthenium, and osmium; at least 0.05% by weight of at least one metal or metal oxide of cerium, lanthanum, or zinc; and at least 0.05% by weight of at least one metal or metal oxide of chromium, manganese, or iron.
